(19) United States
(12) Patent Application Publication
(10) Pub. No.: US 2018/0049008 A1
(43) Pub. Date: Feb. 15, 2018

(54) PLATFORM DEVICE AND DISTRIBUTED PROCESSING METHOD

(71) Applicant: SK PLANET CO., LTD., Seongnam-si Gyeonggi-do (KR)

(72) Inventor: Min Ho Han, Seoul (KR)

(21) Appl. No.: 15/791,076

(22) Filed: Oct. 23, 2017

Related U.S. Application Data
(63) Continuation of application No. PCT/KR2016/000048, filed on Jan. 5, 2016.

(30) Foreign Application Priority Data
Apr. 23, 2015 (KR) KR10-2015-0057192

(51) Int. Cl. H04W 4/20; H04L 29/08

(52) U.S. Cl. CPC H04W 4/206; H04L 67/10; H04L 67/16; G06Q 30/0257

(57) ABSTRACT

A method that includes: converting first service use information on a user to a first service device into first distributed data with a data format for distributed processing; converting second service use information on a user to a second service device into second distributed data with the data format, the second service use information being required to be processed independently of the first service use information; integrating the first distributed data and the second distributed data into third distributed data in which first server identification information on the first service device and second server identification information on the second service device are inserted by changing a specified data value in the data format of each of the first distributed data and the second distributed data; and transmitting the third distributed data to a plurality of distributed processing devices so that distributed processing on the first service use information and the second service use information is able to be performed by the distributed processing devices simultaneously is disclosed.

### CROSS REFERENCE TO RELATED APPLICATIONS

This application is a continuation of and claims priority to PCT Application No. PCT/KR2016/000048, filed on Jan. 5, 2016, which claims priority to Korean Patent Application No. KR10-2015-0057192, filed on Apr. 23, 2015, the entire contents of which are hereby incorporated by reference.

### BACKGROUND OF THE INVENTION

### 1. Field of the Invention

The present specification relates to a method for integrating and processing, in a distributed manner, data including pieces of service user information on users, which are required to be independently processed for each service device in a distributed manner.

### 2. Description of the Prior Art

As the number of applications running on mobile devices, such as smartphones and tablet pads, is rapidly expanding, the available content is also growing at a high speed.

A mobile device (hereinafter, referred to as a ‘terminal device’) can receive and display content provided from a platform device when running an application or accessing a service page (for example, a webpage).

Typically, the terminal device may access the service page by selecting the received content, and a service device (for example, a server) providing the service page may collect service use information on a user and may provide the service use information to the platform device.

The platform device may select particular content through the analysis of service use information received from the service device, and the selected content can be provided as a targeted content to a particular user to the service device.

In some instances, there may be as many service devices providing service use information as the number of content providers providing service pages, and the platform device generally regards pieces of service use information received from the plurality of service devices as unrelated to each other.

The platform device independently analyzes service use information received from each service device for each service device, and this independent analysis method has a limitation in terms of efficiency in that it takes a long time to analyze service use information.

### SUMMARY

The present specification describes solutions to the above-mentioned problems in the prior art and an aspect of the present specification is to integrate and distributedly process pieces of service user information on users, which are required to be independently distributedly processed by each service device.

In general, one innovative aspect of the subject matter described in this specification can be implemented in a method that includes the actions of converting first service use information on a user to a first service device into first distributed data with a data format for distributed processing; converting second service use information on a user to a second service device into second distributed data with the data format, the second service use information being required to be processed independently of the first service use information; integrating the first distributed data and the second distributed data into third distributed data in which first server identification information on the first service device and second server identification information on the second service device are inserted by changing a specified data value in the data format of each of the first distributed data and the second distributed data; and transmitting the third distributed data to a plurality of distributed processing devices so that distributed processing on the first service use information and the second service use information is able to be performed by the distributed processing devices simultaneously.

The foregoing and other implementations can each optionally include one or more of the following features, alone or in combination. In particular, one implementation includes all the following features in combination. The method further includes: generating a first modification value for the first distributed data based on the first server identification information and the specified data value in the data format; and generating a second modification value for the second distributed data based on the second server identification information and the specified data value in the data format. Integrating of the first distributed data and the second distributed data includes: changing the specified data value in the data format for the first distributed data using the first modification value to insert the first server identification information in the first distributed data, and changing the specified data value in the data format for the second distributed data using the second modification value to insert the second server identification information in the second distributed data. The specified data value changed in the first distributed data comprises first product identification information related to a product of interest to the user to the first service device, and wherein the specified data value changed in the second distributed data comprises second product identification information related to a product of interest to the user to the second service device. The method further includes: providing the user to the first service device with an advertisement related to the product of interest corresponding to the first product identification information based on a distributed processing result of the first service use information, and providing the user to the second service device with an advertisement related to the product of interest corresponding to the second product identification information based on a distributed processing result of the second service use information.

In general, another innovative aspect of the subject matter described in this specification can be implemented in a system including one or more computers and one or more memory devices storing one or more commands that, when executed by the one or more computer, cause the one or more computers to perform operations including: obtaining, from a first service device, first service use information that includes information representing one or more activities performed by a first user with respect to the first service device; generating, based on the first service use information, first distributed data having a particular data format that specifies one or more types of information, wherein first type information of the first distributed data is associated with a first value; obtaining, from a second service device, second service use information that includes information representing one or more activities performed by a second user with respect to the second service device; generating, based on the second service use information, second distributed data having the particular data format, wherein first type information of the second distributed data is associated with a second value; generating third distributed data having the particular data format by adjusting the first value of the first distributed data and second value of the second distributed data; and providing the third distributed data to one or more distributed processing devices the third distributed data to process the third distributed data in a distributed manner.

The foregoing and other implementations can each optionally include one or more of the following features, alone or in combination. Generating third distributed data including: verifying that the first distributed data is originated from the first service device and that the second distributed data is originated from the second service device, based on a verification that the first distributed data is originated from the first service device, adjusting the first value that is associated with the first type information of the first distributed data, based on a verification that the second distributed data is originated from the second service device, adjusting the second value that is associated with the first type information of the second distributed data, and generating the third distributed data including (i) the first distributed data having the adjusted first value and (ii) the second distributed data having the adjusted second value. The operations further include: receiving, from the one or more distributed processing devices, results of distributed data processing for the third distributed data; and based on the results of distributed data processing for the third distributed data, generating advertisements for presenting to a user device of the first user or a user device of the second user. Generating advertisements for presenting to a user device of the first user or a user device of the second user includes: classifying the results of distributed data processing for the third distributed data into a first group of the results that is associated with the adjusted first value and a second group of the results that is associated with the adjusted second value; and generating advertisements for presenting the user device of the first user based on the first group of results, and generating advertisements for presenting the user device of the second user based on the second group of results. The user device of the first user is the first service device and the user device of the second user is the second service device. The one or more types of information of the particular data format include product information identifying one or more products in which a user is interested. The one or more types of information of the particular data format include user information identifying a user device of a user. The one or more types of information of the particular data format include preference information representing a user's preference on a particular product.

In general, another innovative aspect of the subject matter described in this specification can be implemented in a method including: obtaining, from a first service device, first service use information that includes information representing one or more activities performed by a first user with respect to the first service device; generating, based on the first service use information, first distributed data having a particular data format that specifies one or more types of information, wherein first type information of the first distributed data is associated with a first value; obtaining, from a second service device, second service use information that includes information representing one or more activities performed by a second user with respect to the second service device; generating, based on the second service use information, second distributed data having the particular data format, wherein first type information of the second distributed data is associated with a second value; generating third distributed data having the particular data format by adjusting the first value of the first distributed data and second value of the second distributed data; and providing the third distributed data to one or more distributed processing devices the third distributed data to process the third distributed data in a distributed manner.

The foregoing and other implementations can each optionally include one or more of the following features, alone or in combination. Generating third distributed data includes: verifying that the first distributed data is originated from the first service device and that the second distributed data is originated from the second service device, based on a verification that the first distributed data is originated from the first service device, adjusting the first value that is associated with the first type information of the first distributed data, based on a verification that the second distributed data is originated from the second service device, adjusting the second value that is associated with the first type information of the second distributed data, and generating the third distributed data including (i) the first distributed data having the adjusted first value and (ii) the second distributed data having the adjusted second value. The operations further include: receiving, from the one or more distributed processing devices, results of distributed data processing for the third distributed data; and based on the results of distributed data processing for the third distributed data, generating advertisements for presenting to a user device of the first user or a user device of the second user. Generating advertisements for presenting to a user device of the first user or a user device of the second user includes: classifying the results of distributed data processing for the third distributed data into a first group of the results that is associated with the adjusted first value and a second group of the results that is associated with the adjusted second value; and generating advertisements for presenting the user device of the first user based on the first group of results, and generating advertisements for presenting the user device of the second user based on the second group of results. The user device of the first user is the first service device and the user device of the second user is the second service device. The one or more types of information of the particular data format include product information identifying one or more products in which a user is interested. The one or more types of information of the particular data format include user information identifying a user device of a user and preference information representing a user's preference on a particular product.

A platform device and an operating method thereof according to the present specification may integrate and distributedly process pieces of service user information on users, which are required to be independently and distributedly processed by each service device (for example, each advertiser's server), thereby considerably reducing the amount of time taken to analyze service use information.

### BRIEF DESCRIPTION OF THE DRAWINGS

FIG. 1 is a diagram illustrating an example distributed data processing system.

FIG. 2 is a diagram illustrating a conventional example distributed data processing system.

FIG. 3 is a diagram illustrating an example terminal device of a distributed data processing system.

FIG. 4 is a diagram illustrating an example platform device of a distributed data processing system.

FIG. 5 is a diagram illustrating example hardware to implement a platform device of a distributed data processing system.

FIG. 6 is a flowchart illustrating an example method for operating a terminal device to of a distributed data processing system.

FIG. 7 is a flowchart illustrating an example method for operating a platform device of a distributed data processing system.

Like reference numbers and designations in the various drawings indicate like elements.

### DETAILED DESCRIPTION

It should be noted that the technical terms as used herein are merely used for describing particular implementations, and are not intended to limit the scope of the present specification. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present specification, the technical term should be replaced with the correct technical term which can be understood by those skilled in the art. Further, the general terms used in the present specification should be interpreted in the context according to the dictionary definition and should not be construed as possessing an excessively limited meaning.

In addition, a singular expression used in the specification includes a plural expression as long as they are clearly distinguished in the context. In the present specification, the term “comprise” or “include” should not be construed as necessarily including all of various elements or various steps disclosed herein, and it should be understood that some of the elements or steps may not be included, or additional elements or steps may be further included.

In addition, although terms including ordinal numbers such as first, second, and the like may be used to describe various elements, the elements should not be restricted by the terms. The terms are used merely for the purpose to distinguish an element from the other elements. For example, a first element may be termed a second element, and similarly, a second element may be termed a first element without departing from the scope of the present specification.

Hereinafter, implementations of the present specification will be described in detail with reference to the accompanying drawings, equal or similar elements are assigned an equal reference numeral, and an overlapping description thereof will be omitted.

Further, in the following description of the technology of the present specification, a detailed description of known technologies incorporated herein will be omitted when it may make the subject matter of the present specification rather unclear. Further, it should be noted that the accompanying drawings are intended only for the easy understanding of the technical idea of the present specification, and the technical idea should not be construed as being limited by the accompanying drawings.

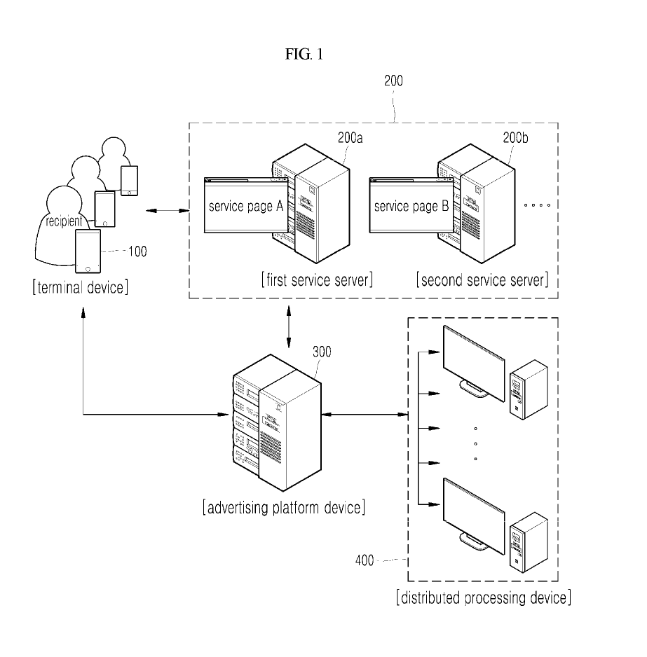

FIG. 1 is a diagram illustrating an example distributed data processing system.

As illustrated in FIG. 1, an advertisement providing system includes a terminal device 100 that receives an advertisement, a service device 200 that provides a service page (for example, a webpage) which the terminal device 100 accesses, and a platform device, e.g., an advertising platform device 300 that provides an advertisement for the terminal device 100.

In addition to the foregoing components, the advertisement providing system may further include a plurality of distributed processing devices 400 that analyze service use information collected by the service device 200.

The terminal device 100 refers to a mobile device that is capable of receiving an advertisement through an advertising medium and performing a series of operations, for example, access to a service page, through the selection of an advertisement.

For example, the terminal device 100 may be a smartphone, a tablet Personal Computer (PC), and a Personal Digital Assistant (PDA). However, the terminal device 100 is not limited thereto, but includes any device capable of receiving an advertisement through an advertising medium and operating a browser to access a service page (for example, a webpage).

In some implementations, the advertising medium that enables the terminal device 100 to receive an advertisement may be, for example, an application running on the terminal device 100 or a service page for the terminal device 100 to be accessed by invoking a browser.

The advertising medium includes a Software Development Kit (SDK) related to the receipt of an advertisement in a development process thereof, and the terminal device 100 ultimately performs a series of operations of requesting, receiving, and displaying an advertisement through the SDK included in the advertising medium.

In some implementations, the advertising medium can also collect advertisement history information performed by the advertising platform device 300. For example, when advertisement receipt and display and advertisement click are performed on an application or service page, the terminal device 100 may collect the advertisement receipt and display and the advertisement click as advertisement history information and may transmit the advertisement history information to the advertising platform device 300.

Further, the terminal device 100 according to the implementation of the present specification receives an advertisement through a pull mode of requesting and receiving an advertisement from the advertising platform device 300 using device identification information thereof.

However, the terminal device 100 may also receive an advertisement through a push mode of receiving an advertisement provided from the advertising platform device 300 without a request for an advertisement from the advertising platform device 300, without being limited to the foregoing advertisement receipt mode.

The service device 200 refers to a web server (for example, an open market or an online shopping mall) that provides a service page which the terminal device 100 accesses through a browser.

The service device 200 may provide various services (for example, for purchasing, selling, and introducing a product) for the terminal device 100 accessing the service page through advertisement selection.

When the accessing terminal device 100 finishes using a service, the service device 200 may provide service use information (for example, a purchased product, a product stored in a cart, and a retrieved product) on the terminal device 100 to the advertising platform device 300, either directly or through the terminal device 100.

The advertising platform device 300 refers to an advertising sever that provides an advertisement for the terminal device 100.

When service use information is received from the service device 200, the advertising platform device 300 may select an advertisement through the analysis of the received service use information, and provides the selected advertisement as a targeted advertisement to the terminal device 100 that accesses the service device.

In some implementations, the advertising platform device 300 analyzes service use information received from the service device 200.

In some implementations, the analysis of the service use information may be performed by the plurality of distributed processing devices 400 through a distributed processing method (for example, MapReduce (MR)).

That is, the advertising platform device 300 converts service use information received from the service device 200 into distributed processing data having a data format for distributed processing (for example, visitor (user) identification information, product identification information, and preference), as in Table 1, and divides and transmits the converted distributed processing data to each of the plurality of distributed processing devices 400, and the plurality of distributed processing devices 400 performs distributed processing on the distributed processing data, thereby analyzing the service use information

TABLE 1

| User identification | Product identification | Preference |
|---|---|---|
| information | information | |
| 1 | 1 | 0.1 |
| 1 | 2 | 0.2 |
| 2 | 1 | 0.15 |

In some implementations, “user identification information” refers to identification information on the terminal device 100 belonging to a user to the service device 200, “product identification information” refers to identification information on a product in which a user is interested (for example, a purchased product, a product stored in a cart, and a retrieved product), and “preference” refers to a type of weighting assigned according to a user's action on the interested product (purchasing, adding to a cart, and search).

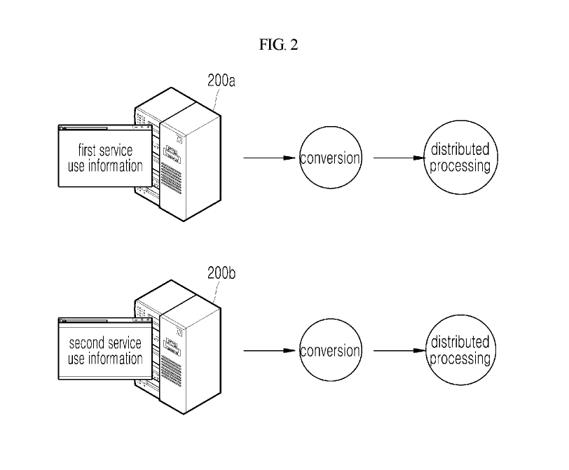

FIG. 2 is a diagram illustrating a conventional example distributed data processing system. In FIG. 2, there are as many service devices 200 providing service use information as the number of advertisers providing a service page, and the advertising platform device 300 generally regards pieces of service use information received from the plurality of service devices 200 as unrelated to each other.

In this example, a first service device 200a and a second service device 200b are described as example service devices among the plurality of service devices 200. However, in some implementations, more than two service devices of the service devices 200 can be used.

When first service use information is received from the first service device 200a and second service use information is received from the second service device 200b, as illustrated in FIG. 2, the advertising platform device 300 can process the first service use information and the second service use information as unrelated to each other, and thus cannot help but perform independent distributed processing on the first service use information and the second service use information.

In some implementations, in order to improve efficiency in distributed processing, a method of simultaneously distributedly processing the first service use information and the second service use information regardless of any association therebetween may be used. However, since there are no data values to distinguish the first service use information from the second service use information in the data format for distributed processing illustrated in Table 1, this method may be expected to have a limitation in that results of distributedly processing the first service use information and the second service use information are not distinguishable from each other.

In addition, to simultaneously distributedly process the first service use information and the second service use information, a method of adding identification information to distinguish the first service use information from the second service use information to the data format for distributed processing may also be considered. However, this method inevitably involves changing the data format defined for distributed processing and thus is inappropriate in practice.

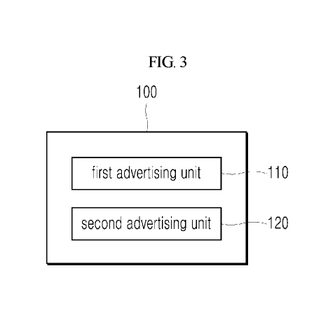

FIG. 3 is a diagram illustrating an example terminal device of a distributed data processing system. In FIG. 3, the terminal device 100 may have a configuration including a first advertising unit 110 and a second advertising unit 120.

The first advertising unit 110 refers to a component that performs a series of operations associated with an advertisement as an application as an advertising medium starts running and may correspond to an SDK embedded in the application.

The second advertising unit 120 refers to a component that performs a series of operations associated with an advertisement according to access to a service page (for example, a webpage) as another advertising medium and may correspond to a browser.

The browser may read source code of the SDK inserted in a service page to perform a series of operations associated with an advertisement upon access to a service page.

The browser serving as the second advertising unit 120 may be an Operating System (OS)-based browser provided from an OS of the terminal device 100 or an application-based browser autonomously provided from an application running on the terminal device 100.

In some implementations, an application capable of autonomously providing a browser may be generally referred to as a hybrid application (for example, a mobile-specific shopping mall application).

All or at least some of the components of the terminal device 100 including the first advertising unit 110 and the second advertising unit 120 may be configured in the form of a software module or a hardware module implemented by a processor or as a combination of a software module and a hardware module.

That is, the terminal device 100 receives and displays an advertisement from the advertising platform device 300 using the foregoing configuration. Hereinafter, each component of the terminal device 100 is described in detail.

The first advertising unit 110 receives an advertisement.

In particular, the first advertising unit 110 requests an advertisement from the advertising platform device 300 according to the running of an application. When an advertisement is received from the advertising platform device 300 in response to the advertisement request, the first advertising unit 110 displays the received advertisement in an advertisement display area designated on an application execution screen.

In some implementations, the first advertising unit 110 may request the advertisement from the advertising platform device 300 using device identification information (for example, an MDN and an IMEI) on the terminal device 100 as the application starts running.

Further, the first advertising unit 110 requests access to the service device 200.

In particular, after displaying the advertisement received from the advertising platform device 300 in the advertisement display area of the application execution screen, the first advertising unit 110 requests the second advertising unit 120 to access the service device 200 when identifying a click on the advertisement.

In some implementations, the clicked advertisement may include address information on the service device 200. When a click on the advertisement is identified, the first advertising unit 110 may transmit the address information included in the advertisement to the second advertising unit 120, thereby requesting access to the service device 200.

The second advertising unit 120 accesses a service page.

In particular, when a click on the advertisement in the application is identified by the first advertising unit 110, the second advertising unit 120 may access the service device 200 using the address information transmitted from the first advertising unit 110, thus enabling the use of various services (for example, a product purchasing service) provided by the service device 200.

in some implementations, the second advertising unit 120 is a different advertising medium from the first advertising unit 110 and is a component performing a series of operations associated with an advertisement according to access to a service page (for example, a webpage).

The second advertising unit 120 may request an advertisement from the advertising platform device 300 according to access to a service page (for example, a webpage), separately from the first advertising unit 110. When an advertisement is received from the advertising platform device 300 according to the advertisement request, the second advertising unit 120 may display the received advertisement in an advertisement display area on the service page.

In addition, similarly to the first advertising unit 110, after displaying the advertisement received from the advertising platform device 300 in the advertisement display area of the service page, when a click on the advertisement is identified, the second advertising unit 120 may access the service device 200 using address information inserted in the advertisement to use various services (for example, a product-selling service) provided by the service device 200.

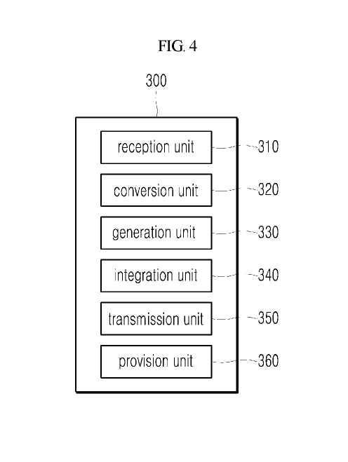

FIG. 4 is a diagram illustrating an example platform device of a distributed data processing system. In FIG. 4, the platform device is an advertisement platform apparatus 300.

The advertisement platform apparatus 300 includes: a reception unit 310 that receives first service use information from the first service device 200a and receives second service use information from the second service device 200b; a conversion unit 320 that converts the first service use information into first distributed data and converts the second service use information into second distributed data; a generation unit 330 that generates a first modification value for the first distributed data and generates a second modification value for the second distributed data; an integration unit 340 that integrates the first distributed data and the second distributed data into third distributed data; a transmission unit 350 that divides and transmits the third distributed data to the plurality of distributed processing devices 400; and a provision unit 360 that provides an advertisement based on a distributed processing result.

All or at least some of the components of the advertising platform device 300 including the reception unit 310, the conversion unit 320, the generation unit 330, the integration unit 340, the transmission unit 350, and the provision unit 360 may be configured in the form of a software module or a hardware module implemented by a processor or as a combination of a software module and a hardware module.

That is, the advertising platform device 300 performs simultaneous distributed processing on the first service use information received from the first service device 200a and the second service use information received from the second service device 200b using the foregoing configuration. Hereinafter, each component of the advertising platform device 300 is described in detail.

The reception unit 310 receives service use information.

In particular, the reception unit 310 receives first service use information as service use information on users from the first service device 200a and receives second service use information as service use information on users from the second service device 200b to transmit the first service use information and the second service use information to the conversion unit 320.

The conversion unit 320 converts the first service use information and the second service use information.

In particular, when the first service use information and the second service use information are received from the reception unit 310, the conversion unit 320 converts the first service use information into first distributed data as distributed data having a data format for distributed processing, converts the second service use information into second distributed data as distributed data having a data format for distributed processing, and transmits the first distributed data and the second distributed data to the generation unit 330.

In some implementations, the data format for distributed processing may include ‘user identification information,’ ‘product identification information,’ and ‘preference’ as illustrated above in Table 1.

The generation unit 330 generates a modification value for the first distributed data and the second distributed data.

In particular, when the first distributed data and the second distributed data are received from the conversion unit 320, the generation unit 330 generates a first modification value for changing a specified data value in the data format of the first distributed data and generates a second modification value for changing a specified data value in the data format of the second distributed data.

In some implementations, the specified data value refers to ‘product identification information’ as a data value in the data format illustrated in Table 1.

In some implementations, the generation unit 330 generates the first modification value for the first distributed data based on first server identification information, which is identification information on the first service device 200a, and first product identification information, which is product identification information on a product that is of interest to a user to the first service device 200a, and generates the second modification value for the second distributed data based on second server identification information, which is identification information on the second service device 200b, and second product identification information, which is product identification information on a product that is of interest to a user to the second service device 200b.

In some implementations, the first modification value and the second modification value are identification information generated respectively using first server identification information and first product identification information and using second server to identification information and second product identification information as key values, and may be generated as shown below in Table 2.

TABLE 2

| | Product | |
|---|---|---|
| Server identification | identification | |
| information | information | Modification value |
| A (first server | 1 | 1 (first modification |
| identification information) | | value) |
| B (second server | 1 | 2 (second modification |
| identification information) | | value) |
| A (first server | 2 | 3 (first modification |
| identification information) | | value) |
| B (second server | 2 | 4 (second modification |
| identification information) | | value) |
| . . . | . . . | . . . |

When the first modification value and the second modification value are generated, the generation unit 330 transmits the first modification value, the first distributed data, the second modification value, and the second distributed data to the integration unit 340.

The integration unit 340 integrates the first distributed data and the second distributed data.

In particular, the integration unit 340 changes product identification information as a specified data value in the data format with respect to each of the first distributed data and the second distributed data, thereby integrating the first distributed data and the second distributed data into third distributed data with the first server identification information and the second server identification information inserted.

In some implementations, the integration unit 340 changes the product identification information in the data format using the first modification value for the first distributed data to insert the first server identification information in the first distributed data, and changes the product identification information in the data format using the second modification value for the second distributed data to insert the second server identification information in the second distributed data.

That is, the first distributed data and the second distributed data with the data format having the product identification information changed with the first modification value and the second modification value maintains the data format for distributed processing shown in Table 3, and may be integrated into the third distributed data with the first server identification information and the second server identification information inserted.

TABLE 3

| User identification | Modification value (existing, | |
|---|---|---|
| information | product identification information) | Preference |
| 1 | 1 | 0.1 |
| 1 | 3 | 0.2 |
| 2 | 1 | 0.15 |

When the first distributed data and the second distributed data are integrated into the third distributed data, the integration unit 340 transmits the third distributed data to the transmission unit 350.

The transmission unit 350 divides and transmits the third distributed data to the plurality of distributed processing devices 400.

In particular, when the third distributed data is received from the integration unit 340, the transmission unit 350 divides and transmits the third distributed data to the plurality of distributed processing devices 400, and the plurality of distributed processing devices 400 performs distributed processing on the third distributed data, thereby achieving the simultaneous analysis of the first service use information and the second service use information.

The transmission unit 350 receives distributed processing results from the plurality of distributed processing devices 400 and transmits the distributed processing results to the provision unit 360, and the distributed processing results may be arranged as shown in Table 4.

TABLE 4

| User | Modification value | Distributed |
|---|---|---|
| identification | (existing product | processing result |
| information | identification infoimation) | (Recommended level) |
| 1 | 1 | 19 |
| 1 | 3 | 16 |
| 2 | 1 | 18 |

In some implementations, the distributed processing results may be defined as a recommendation level to provide an advertisement related to a product of interest with respect to each of the users of the first service device 200a and the second service device 200b.

The provision unit 360 provides an advertisement.

In particular, when the distributed processing results are received from the transmission unit 350, the provision unit 360 classifies the distributed processing results into a distributed processing result of the first service use information (first distributed data) and a distributed processing result of the second service use information (second distributed data), and provides an advertisement for a product of interest to a user to the first service device 200a and a user to the second service device 200b according to the classified distributed processing results (recommended level).

In some implementations, when the first modification value and the second modification value, which are data values in a data format of the distributed processing results, are restored respectively to the first server identification information and the first product identification information, and to the second server identification information and the second product identification information, which are existing data values before the change, the distributed processing results are listed as in Table 5.

TABLE 5

| User | Server | Product | Distributed processing |
|---|---|---|---|
| identification | identification | identification | result (Recommended |
| information | information | information | level) |
| 1 | A (first server | 1 | 19 |
| | identification | | |
| | information) | | |
| 1 | B (second server | 1 | 16 |
| | identification | | |
| | information) | | |
| 2 | A (first server | 2 | 18 |
| | identification | | |
| | information) | | |

The provision unit 360 restores the first modification value and the second modification value, which are data values in the data format of the distributed processing results, respectively to the first server identification information and the first product identification information, and to the second server identification information and the second product identification information, which are existing data values before the change, thereby classifying the distributed processing results received from the transmission unit 350 into the distributed processing result of the first service use information (first distributed data) and the distributed processing result of the second service use information (second distributed data).

That is, when the distributed processing results of the first service use information (first distributed data) and the second service use information (second distributed data) are classified according to the foregoing restoration method, the provision unit 360 may provide a user to the first service device 200a with an advertisement for a product of interest corresponding to the first product identification information based on the distributed processing result of the first service use information (first distributed data) and may provide a user to the second service device 200b with an advertisement for a product of interest corresponding to the second product identification information based on the distributed processing result of the second service use information (second distributed data).

In some implementations, each component of the advertising platform device 300 may be configured in the form of a software module or hardware module implemented by a processor or in a combination of a software module and a hardware module.

A software module or hardware module implemented by a processor or a combination of a software module and a hardware module may be configured in a hardware system (for example, a computer system).

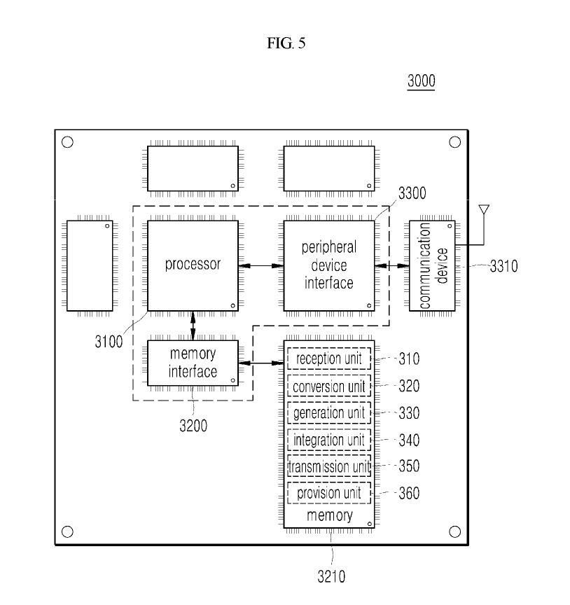

FIG. 5 is a diagram illustrating example hardware to implement a platform device of a distributed data processing system. In some implementations, a hardware system 3000 can be used to implement an advertising platform device, e.g., the advertising platform device 300. However, the hardware system 3000 is one example of various implementations and any suitable hardware can be used to implement the advertising platform device.

The hardware system 3000 to configure the advertising platform device 300 may have a configuration including a processor 3100, a memory interface 3200, and a peripheral device interface 3300.

The respective components of the hardware system 3000 may be provided as individual components or may be integrated in one or more integrated circuits. These components may be coupled to a bus system (not shown).

In some implementations, the bus system is an abstraction representing one or more individual physical buses, communication lines/interfaces, and/or multi-drop or point-to-point connections connected via appropriate bridges, adaptors, and/or controllers.

The processor 3100 serves to execute various software modules stored in the memory 3210 by communicating with the memory 3210 via the memory interface 3200 in order to perform various tasks in the hardware system.

The memory 3210 may store the reception unit 310, the conversion unit 320, the generation unit 330, the integration unit 340, the transmission unit 350, and the provision unit 360, which are components of the advertising platform device 300 described with reference to FIG. 4, in the form of a software module, and may additionally store an operating system.

The operating system (for example, an embedded operating system, such as iOS, Android, Darwin, RTXC, LINUX, UNIX, OSX, WINDOWS, or VxWorks) includes various procedures, command sets, software components and/or drivers to control and manage general system operations (for example, memory management, storage device control, and power management) and serves to facilitate communication between various hardware modules and software modules.

In some implementations, the memory 3210 includes a cache, a main memory, and a secondary memory. However, the memory 3210 is not limited thereto, but may include a memory hierarchy, which may be configured, for example, in any combination of RAM (for example, SRAM, DRAM, and DDRAM), ROM, flash memory, and a magnetic and/or optical storage device (for example, a disk drive, a magnetic tape, a Compact Disk (CD), and a Digital Video Disc (DVD)).

The peripheral device interface 330 serves to enable communication between the processor 3100 and a peripheral device.

The peripheral device is to provide additional capabilities to the computer system and may include, for example, a communication device 3310.

The communication device 3310 enables the computer system to communicate with another device and accordingly includes, for example, an antenna system, a radio frequency (RF) transceiver, one or more amplifiers, a tuner, one or more oscillators, a digital signal processor, a codec chipset, and a memory. However, the communication device 3310 is not limited thereto, but may include a known circuit to perform various tasks described above.

The communication device 3310 may support a communication protocol, for example, Long Term Evolution (LTE), Time Division Multiple Access (TDMA), Code Division Multiple Access (CDMA), Global System for Mobile communications (GSM), Enhanced Data GSM Environment (EDGE), Wideband Code Division Multiple Access (W-CDMA), Wi-Fi (IEEE 802.11a, IEEE 802.11b, IEEE 802.11g and/or IEEE 802.11n), Bluetooth, Wi-MAX, Voice over Internet Protocol (VoIP), and protocols for email, instant messaging and Short Message Service (SMS). However, the communication protocol supported by the communication device 3310 is not limited thereto, but may include any protocol providing an environment for communication with another device.

That is, when run by the processor 3100, the components of the advertising platform device 300, which are stored in the soft module forms in the memory 3210, perform communications with the communication device 3310 and an input/output device 2320 via the memory interface 3200 and the peripheral device interface 3300, thereby performing simultaneous distributed processing on the first service use information received from the first service device 200a and the second service use information received from the second service device 200b.

Hereinafter, each component of the hardware system 3000 to configure the advertising platform device 300 is described in detail with reference to FIG. 5.

For convenience of description, it is assumed that the components of the advertising platform device 300, which are stored in the soft module forms in the memory 3210, are run by the processor 3100.

The reception unit 310 receives service use information.

In particular, the reception unit 310, through the communication device 3310, receives first service use information as service use information on users from the first service device 200a and receives second service use information as service use information on users from the second service device 200b to transmit the first service use information and the second service use information to the conversion unit 320.

The conversion unit 320 converts the first service use information and the second service use information.

In particular, when the first service use information and the second service use information are received from the reception unit 310, the conversion unit 320 converts the first service use information into first distributed data as distributed data having a data format for distributed processing, converts the second service use information into second distributed data as distributed data having a data format for distributed processing, and transmits the first distributed data and the second distributed data to the generation unit 330.

The generation unit 330 generates a modification value for the first distributed data and the second distributed data.

In particular, when the first distributed data and the second distributed data are received from the conversion unit 320, the generation unit 330 generates a first modification value for changing a specified data value in the data format of the first distributed data and generates a second modification value for changing a specified data value in the data format of the second distributed data.

In some implementations, the generation unit 330 generates the first modification value for the first distributed data based on first server identification information, which is identification information on the first service device 200a, and first product identification information, which is product identification information on a product that is of interest to a user to the first service device 200a, and generates the second modification value for the second distributed data based on second server identification information, which is identification information on the second service device 200b, and second product identification information, which is product identification information on a product that is of interest to a user to the second service device 200b.

In some implementations, when the first modification value and the second modification value are generated, the generation unit 330 transmits the first modification value, the first distributed data, the second modification value, and the second distributed data to the integration unit 340.

The integration unit 340 integrates the first distributed data and the second distributed data.

In particular, the integration unit 340 changes product identification information as a specified data value in the data format with respect to each of the first distributed data and the second distributed data, thereby integrating the first distributed data and the second distributed data into third distributed data with the first server identification information and the second server identification information inserted.

In some implementations, the integration unit 340 changes the product identification information in the data format using the first modification value for the first distributed data to insert the first server identification information in the first distributed data, and changes the product identification information in the data format using the second modification value for the second distributed data to insert the second server identification information in the second distributed data.

When the first distributed data and the second distributed data are integrated into the third distributed data, the integration unit 340 transmits the third distributed data to the transmission unit 350.

The transmission unit 350 divides and transmits the third distributed data to the plurality of distributed processing devices 400.

In particular, when the third distributed data is received from the integration unit 340, the transmission unit 350 divides and transmits the third distributed data to the plurality of distributed processing devices 400 through the communication device 3310, and the plurality of distributed processing devices 400 performs distributed processing on the third distributed data, thereby achieving simultaneous analysis of the first service use information and the second service use information.

The transmission unit 350 receives distributed processing results from the plurality of distributed processing devices 400 and transmits the distributed processing results to the provision unit 360.

The provision unit 360 provides an advertisement.

In particular, when the distributed processing results are received from the transmission unit 350, the provision unit 360 classifies the distributed processing results into a distributed processing result of the first service use information (first distributed data) and a distributed processing result of the second service use information (second distributed data), and provides, through the communication device 3310, an advertisement for a product of interest to a user to the first service device 200a and a user to the second service device 200b according to the classified distributed processing results (recommended level).

In some implementations, the provision unit 360 restores the first modification value and the second modification value, which are data values in the data format of the distributed processing results, respectively to the first server identification information and the first product identification information, and to the second server identification information and the second product identification information, which are existing data values before the change, thereby classifying the distributed processing results received from the transmission unit 350 into the distributed processing result of the first service use information (first distributed data) and the distributed processing result of the second service use information (second distributed data).

As described above, according to the advertising platform device 300 and the hardware system 3000 to configure the same, in performing simultaneous distributed processing on the first service use information received from the first service device 200a and the second service use information received from the second service device 200b, the data format for distributed processing is maintained despite the insertion of the server identification information to distinguish the first service use information and the second service use information, thus enabling normal distributed processing in the plurality of distributed processing devices 400. Further, simultaneous distributed processing on the first service use information and the second service use information may lead to a considerable reduction in the amount of time taken to analyze the first service use information and the second service use information.

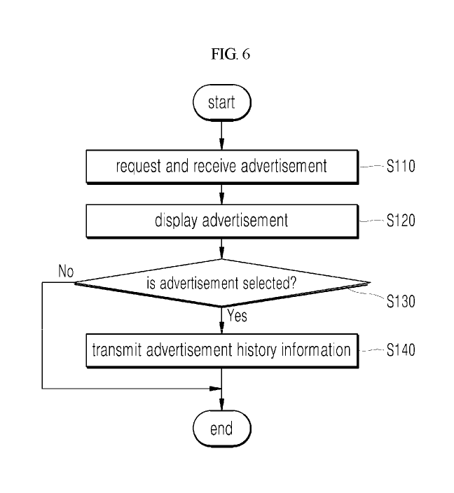

FIG. 6 is a flowchart illustrating an example method for operating a terminal device of a distributed data processing system. For example, the terminal device described with reference to FIGS. 1 to 5 can be the terminal device to be operated by the method in FIG. 6.

A first advertising unit, e.g., the first advertising unit 110, requests an advertisement from a platform device, e.g., the advertising platform device 300, according to the running of an application. When an advertisement is received from the advertising platform device 300 in response to the advertisement request, the first advertising unit 110 displays the received advertisement in an advertisement display area designated on an application execution screen (S110 and S120).

In some implementations, the first advertising unit 110 may request the advertisement from the advertising platform device 300 using device identification information (for example, an MDN and an IMEI) on the terminal device 100 as the application starts running.

The second advertising unit, e.g., the second advertising unit 120, is a different advertising medium from the first advertising unit 110 and is a component performing a series of operations associated with an advertisement in response to access to a service page (for example, a webpage).

Thus, the second advertising unit 120 may request an advertisement from the advertising platform device 300 according to access to a service page (for example, a webpage), separately from the first advertising unit 110. When an advertisement is received from the advertising platform device 300 according to the advertisement request, the second advertising unit 120 may display the received advertisement in an advertisement display area on the service page.

Subsequently, after displaying the advertisement received from the advertising platform device 300 in the advertisement display area of the application execution screen, the first advertising unit 110 requests the second advertising unit 120 to access the service device 200 when identifying a click on the advertisement (S130 and S140).

In some implementations, when a click on the advertisement is identified, the first advertising unit 110 may transmit address information included in the advertisement to the second advertising unit 120, thereby requesting access to the service device 200.

The first advertising unit 110 displays the advertisement received from the advertising platform device 300 in the advertisement display area of the service page. When a click on the displayed advertisement is identified, the second advertising unit 120 may access the service device 200 using address information inserted in the advertisement to use various services (for example, a product-selling service) provided by the service device 200.

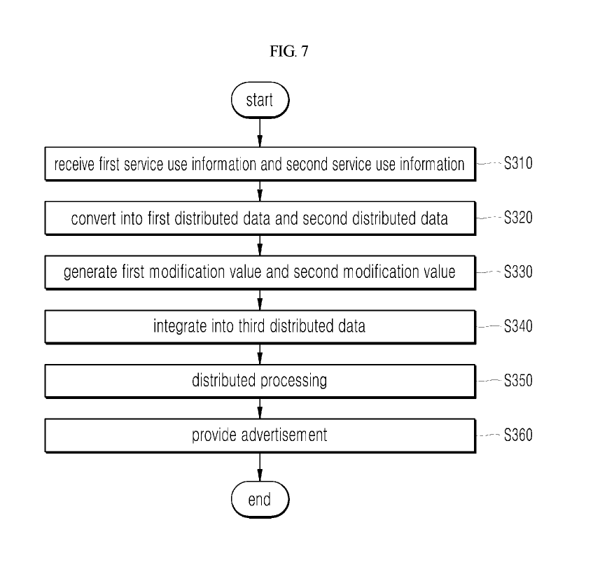

FIG. 7 is a flowchart illustrating an example method for operating a platform device of a distributed data processing system. For example, the platform device 300 described with reference to FIGS. 1 to 5 can be the platform device operated by the method of FIG. 7.

A reception unit, e.g., reception unit 310 of the platform device 300, receives first service use information as service use information on users from the first service device 200a and receives second service use information as service use information on users from the second service device 200b (S310).

When the first service use information and the second service use information are received from the reception unit 310, a conversion unit, e.g., conversion unit 320, converts the first service use information into first distributed data as distributed data having a data format for distributed processing, and converts the second service use information into second distributed data as distributed data having a data format for distributed processing (S320).

When the first distributed data and the second distributed data are received from the conversion unit 320, a generation unit, e.g., generation unit 330, generates a first modification value for changing a specified data value in the data format of the first distributed data and generates a second modification value for changing a specified data value in the data format of the second distributed data (S330).

In some implementations, the generation unit 330 generates the first modification value for the first distributed data based on first server identification information, which is identification information on the first service device 200a, and first product identification information, which is product identification information on a product that is of interest to a user to the first service device 200a, and generates the second modification value for the second distributed data based on second server identification information, which is identification information on the second service device 200b, and second product identification information, which is product identification information on a product that is of interest to a user to the second service device 200b.

An integration unit, e.g., integration unit 340, changes product identification information as a specified data value in the data format with respect to each of the first distributed data and the second distributed data, thereby integrating the first distributed data and the second distributed data into third distributed data with the first server identification information and the second server identification information inserted (S340).

In some implementations, the integration unit 340 changes the product identification information in the data format using the first modification value for the first distributed data to insert the first server identification information in the first distributed data, and changes the product identification information in the data format using the second modification value for the second distributed data to insert the second server identification information in the second distributed data.

When the third distributed data is received from the integration unit 340, a transmission unit, e.g., transmission unit 350, divides and transmits the third distributed data to the plurality of distributed processing devices 400 through the communication device 3310, and the plurality of distributed processing devices 400 performs distributed processing on the third distributed data, thereby achieving simultaneous analysis of the first service use information and the second service use information (S350).

Subsequently, when the distributed processing results are received from the transmission unit 350, a provision unit, e.g., provision unit 360, classifies the distributed processing results into a distributed processing result of the first service use information (first distributed data) and a distributed processing result of the second service use information (second distributed data), and provides, through the communication device 3310, an advertisement for a product of interest to a user to the first service device 200a and a user to the second service device 200b according to the classified distributed processing results (recommended level) (S360).

In some implementations, the provision unit 360 restores the first modification value and the second modification value, which are data values in the data format of the distributed processing results, respectively to the first server identification information and the first product identification information, and to the second server identification information and the second product identification information, which are existing data values before the change, thereby classifying the distributed processing results received from the transmission unit 350 into the distributed processing result of the first service use information (first distributed data) and the distributed processing result of the second service use information (second distributed data).

As described above, according to the operational flow in the advertising platform device 300, in performing simultaneous distributed processing on the first service use information received from the first service device 200a and the second service use information received from the second service device 200b, the data format for distributed processing is maintained despite the insertion of the server identification information to distinguish the first service use information and the second service use information, thus enabling normal distributed processing in the plurality of distributed processing devices 400. Further, simultaneous distributed processing on the first service use information and the second service use information may lead to a considerable reduction in the amount of time taken to analyze the first service use information and the second service use information.

The implementations of the operations and subject matter described in the present specification may be realized by a digital electronic circuit, by the structure described in the present specification and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

Implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations on the scope of any specification or of what may be claimed, but rather as descriptions of features that may be specific to particular implementation. Certain features that are described in the specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should not be understood that the operations are performed in the shown specific sequence or that all shown operations are performed in order to obtain a preferable result. In a specific case, a multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present specification. Therefore, while the present specification was described in detail with reference to the above-mentioned examples, a person skilled in the art may modify, change and transform some parts without departing a scope of the present specification. The scope of the present specification is defined by the appended claims to be described later, rather than the detailed description. Accordingly, it will be appreciated that all modifications or variations derived from the meaning and scope of the appended claims and their equivalents are included in the range of the present specification.

What is claimed is:

1. A method comprising:
converting first service use information on a user to a first service device into first distributed data with a data format for distributed processing;
converting second service use information on a user to a second service device into second distributed data with the data format, the second service use information being required to be processed independently of the first service use information;
integrating the first distributed data and the second distributed data into third distributed data in which first server identification information on the first service device and second server identification information on the second service device are inserted by changing a specified data value in the data format of each of the first distributed data and the second distributed data; and
transmitting the third distributed data to a plurality of distributed processing devices so that distributed processing on the first service use information and the second service use information is able to be performed by the distributed processing devices simultaneously.

2. The method of claim 1, further comprising:
generating a first modification value for the first distributed data based on the first server identification information and the specified data value in the data format; and
generating a second modification value for the second distributed data based on the second server identification information and the specified data value in the data format.

3. The method of claim 2, wherein integrating of the first distributed data and the second distributed data comprises:
changing the specified data value in the data format for the first distributed data using the first modification value to insert the first server identification information in the first distributed data, and
changing the specified data value in the data format for the second distributed data using the second modification value to insert the second server identification information in the second distributed data.

4. The method of claim 1, wherein the specified data value changed in the first distributed data comprises first product identification information related to a product of interest to the user to the first service device, and
wherein the specified data value changed in the second distributed data comprises second product identification information related to a product of interest to the user to the second service device.

5. The method of claim 4, further comprising:
providing the user to the first service device with an advertisement related to the product of interest corresponding to the first product identification information based on a distributed processing result of the first service use information, and
providing the user to the second service device with an advertisement related to the product of interest corresponding to the second product identification information based on a distributed processing result of the second service use information.

6. A system comprising one or more computers and one or more memory devices storing one or more commands that, when executed by the one or more computer, cause the one or more computers to perform operations comprising:
obtaining, from a first service device, first service use information that includes information representing one or more activities performed by a first user with respect to the first service device;
generating, based on the first service use information, first distributed data having a particular data format that specifies one or more types of information, wherein first type information of the first distributed data is associated with a first value;
obtaining, from a second service device, second service use information that includes information representing one or more activities performed by a second user with respect to the second service device;
generating, based on the second service use information, second distributed data to having the particular data format, wherein first type information of the second distributed data is associated with a second value;
generating third distributed data having the particular data format by adjusting the first value of the first distributed data and second value of the second distributed data; and
providing the third distributed data to one or more distributed processing devices the third distributed data to process the third distributed data in a distributed manner.

7. The system of claim 6, wherein generating third distributed data comprising:
verifying that the first distributed data is originated from the first service device and that the second distributed data is originated from the second service device,
based on a verification that the first distributed data is originated from the first service device, adjusting the first value that is associated with the first type information of the first distributed data,
based on a verification that the second distributed data is originated from the second service device, adjusting the second value that is associated with the first type information of the second distributed data, and
generating the third distributed data including (i) the first distributed data having the adjusted first value and (ii) the second distributed data having the adjusted second value.

8. The system of claim 6, wherein the operations further comprise:
receiving, from the one or more distributed processing devices, results of distributed data processing for the third distributed data; and
based on the results of distributed data processing for the third distributed data, generating advertisements for presenting to a user device of the first user or a user device of the second user.

9. The system of claim 8, wherein generating advertisements for presenting to a user device of the first user or a user device of the second user comprises:
classifying the results of distributed data processing for the third distributed data into a first group of the results that is associated with the adjusted first value and a second group of the results that is associated with the adjusted second value; and
generating advertisements for presenting the user device of the first user based on the first group of results, and
generating advertisements for presenting the user device of the second user based on the second group of results.

10. The system of claim 9, wherein the user device of the first user is the first service device and the user device of the second user is the second service device.

11. The system of claim 6, wherein the one or more types of information of the particular data format include product information identifying one or more products in which a user is interested.

12. The system of claim 6, wherein the one or more types of information of the particular data format include user information identifying a user device of a user.

13. The system of claim 6, wherein the one or more types of information of the particular data format include preference information representing a user's preference on a particular product.

14. A method comprising:
obtaining, from a first service device, first service use information that includes information representing one or more activities performed by a first user with respect to the first service device;
generating, based on the first service use information, first distributed data having a particular data format that specifies one or more types of information, wherein first type information of the first distributed data is associated with a first value;
obtaining, from a second service device, second service use information that includes information representing one or more activities performed by a second user with respect to the second service device;
generating, based on the second service use information, second distributed data having the particular data format, wherein first type information of the second distributed data is associated with a second value;
generating third distributed data having the particular data format by adjusting the first value of the first distributed data and second value of the second distributed data; and
providing the third distributed data to one or more distributed processing devices the third distributed data to process the third distributed data in a distributed manner.

15. The method of claim 14, wherein generating third distributed data comprising:
verifying that the first distributed data is originated from the first service device and that the second distributed data is originated from the second service device,
based on a verification that the first distributed data is originated from the first service device, adjusting the first value that is associated with the first type information of the first distributed data,
based on a verification that the second distributed data is originated from the second service device, adjusting the second value that is associated with the first type information of the second distributed data, and
generating the third distributed data including (i) the first distributed data having the adjusted first value and (ii) the second distributed data having the adjusted second value.

16. The method of claim 14, wherein the operations further comprise:
receiving, from the one or more distributed processing devices, results of distributed data processing for the third distributed data; and
based on the results of distributed data processing for the third distributed data, generating advertisements for presenting to a user device of the first user or a user device of the second user.

17. The method of claim 16, wherein generating advertisements for presenting to a user device of the first user or a user device of the second user comprises:
classifying the results of distributed data processing for the third distributed data into a first group of the results that is associated with the adjusted first value and a second group of the results that is associated with the adjusted second value; and
generating advertisements for presenting the user device of the first user based on the first group of results, and
generating advertisements for presenting the user device of the second user based on the second group of results.

18. The method of claim 17, wherein the user device of the first user is the first service device and the user device of the second user is the second service device.

19. The method of claim 14, wherein the one or more types of information of the particular data format include product information identifying one or more products in which a user is interested.

20. The method of claim 14, wherein the one or more types of information of the particular data format include user information identifying a user device of a user and preference information representing a user's preference on a particular product.
